(19) United States
(12) Patent Application Publication
(10) Pub. No.: US 2015/0151991 A1
(43) Pub. Date: Jun. 4, 2015

(54) NEUTRALIZATION METHOD

(71) Applicant: SUMITOMO METAL MINING CO., LTD., Tokyo (JP)

(72) Inventors: Hirotaka Higuchi, Tokyo (JP); Isao Nishikawa, Tokyo (JP)

(21) Appl. No.: 14/405,055

(22) PCT Filed: Jun. 10, 2013
(86) PCT No.: PCT/JP2013/065958

§ 371 Date: Dec. 2, 2014

(30) Foreign Application Priority Data
Jun. 12, 2012 (JP) 2012-133125

(51) Int. Cl. C02F 1/66; C22B 3/00

(52) U.S. Cl. CPC C02F 1/66; C22B 23/043; C22B 23/0461; C02F 2101/203

(57) ABSTRACT

A method for reducing usage amount of expensive high alkaline neutralizer, and applying efficient neutralization treatment, when applying a neutralization treatment to a barren solution to produce in a treatment step, in which a sulfide compose of nickel and cobalt is produced from a sulfuric acid aqueous solution containing nickel and cobalt, and impurity metals containing at least one or more of iron, magnesium, and manganese. A first neutralization treatment step of applying a neutralization treatment to the barren solution, with a range of pH 5.0 to 6.0 as the end point, by using calcium carbonate slurry, as a first neutralizer; and a second neutralization treatment step of applying a neutralization treatment to a solution produced in the first neutralization treatment step, by using a second neutralizer, to produce sediment containing metal remained in the barren solution and a post-neutralization solution from which a metal ion is removed.

### FIELD OF THE INVENTION

The present invention relates to a neutralization method, more specifically, to a neutralization method for neutralizing and removing a metal impurity ion remained in a barren solution produced through a sulfurization treatment for producing a sulfide containing nickel and cobalt by blowing a hydrogen sulfide gas into a sulfuric acid aqueous solution containing nickel, cobalt, and impurity metal elements.

This application claims priority to Japanese Patent Application No. 2012-133125 filed on Jun. 12, 2012, the entire contents of which are incorporated by reference herein.

### BACKGROUND OF THE INVENTION

Recently, the High Pressure Acid Leach (HPAL) using sulfuric acid has been gathering attention as a hydrometallurgical process for nickel oxide ore. This process does not include dry processes, such as a reduction process and a drying process or the like, unlike the pyrometallurgy process that is a conventional common metallurgical process for nickel oxide ore, but includes a consistent wet process. Thus, it is advantageous in terms of energy and cost. Additionally, the process has the advantage of capable of producing a sulfide containing nickel whose nickel grade is upgraded up to about 50 wt % or so (hereinafter, referred to as a “nickel sulfide”). The nickel sulfide is precipitated and produced by blowing into a hydrogen sulfide gas, and generating a sulfurization reaction in a sulfurization step after purifying leachate produced by leaching the nickel oxide ore (see, for example, PTL1).

Incidentally, in the sulfurization step of the hydrometallurgical process for nickel oxide ore, applying the sulfurization treatment in which the hydrogen sulfide gas is blown into the sulfuric acid aqueous solution containing chiefly the nickel, as mentioned above, produces a sulfide containing the nickel or the like and a barren solution whose nickel concentration is stabilized at a low level.

The barren solution produced in the sulfurization step is a solution containing iron, magnesium, and manganese remained without being subjected to sulfurization, and has low pH. Accordingly, when discharging the barren solution, it becomes necessary to apply the neutralization treatment to remove a residual metal ion.

Conventionally, it has been used heretofore a method in which neutralization is applied by using mainly one type of neutralizer, as a method for neutralizing the barren solution. It is mandatory, in this method, to use a high alkaline neutralizer, to achieve pH necessary for neutralization. Specifically, it may use caustic soda and sodium carbonate or the like as an example of probable high alkaline neutralizer, but they are disadvantageous in terms of cost. Therefore, it is often used industrially slaked lime slurry, for example.

However, such a high alkaline neutralizer is typically packed up by a flexible container or the like, and involves a cumbersome pretreatment and a pretreatment facility therefor when the usage amount of neutralizer increases. Further, although neutralizer such as slaked lime slurry is advantageous in terms of cost as compared with another neutralizer, there still remains a problem unsolved that it has a great impact on a finish cost, when the usage amount of neutralizer swells up stupendously due to the increased amount of generation of a barren solution from the sulfurization step.

### PRIOR ART DOCUMENT

### Patent Document

PTL1: Japanese Patent Application Laid-Open No. 2005-350766

### SUMMARY OF THE INVENTION

The present invention is proposed in view of such actual circumstances the prior art intrinsically entails, and an object of the present invention is to provide a neutralization method capable of reducing the usage amount of expensive high alkaline neutralizer, and applying an effective neutralization treatment, when applying a neutralization treatment to a barren solution to be generated through treatment steps for producing nickel and cobalt from a sulfuric acid solution containing the nickel, the cobalt, and impurity metal elements.

As a result of intensive study made by the inventors of the present invention in order to attain the above-mentioned object, it was found that the reduction of the usage amount of expensive neutralizer can be achieved, for example, by replacing a portion of neutralizer to be used, such as slaked lime slurry with inexpensive calcium carbonate slurry, and applying a gradual neutralization treatment whose pH at an end point is adjusted by using two types of neutralizers, in the neutralization and removal steps of the impurity metal elements in a barren solution. Thus, the inventors finally completed their invention.

Namely, a neutralization method for neutralizing and removing a metal ion remained in a barren solution produced through a sulfurization treatment for producing a sulfide containing nickel and cobalt by blowing a hydrogen sulfide gas into a sulfuric acid aqueous solution containing the nickel and the cobalt, and impurity metals containing any of iron, magnesium, and manganese at least one or more, the method comprises: a first neutralization treatment step of applying a neutralization treatment to the barren solution, with a range of pH 5.0 to 6.0 as the end point, using calcium carbonate slurry as a first neutralizer; and a second neutralization treatment step of applying a neutralization treatment to a solution produced in the first neutralization treatment step by using a second neutralizer to produce a sediment containing metals remained in the barren solution and a post-neutralized solution from which the metal ion is removed.

It is preferable for the second neutralizer to be slaked lime slurry.

It is preferable for pH at the end point in the first neutralization treatment step to be within a range of 5.4 to 5.8.

In the second neutralization treatment step, it is preferable for a neutralization treatment to be conducted with a range of pH 8.5 to 9.5 as the end point.

In a hydrometallurgical process based on high pressure acid leach for recovering the nickel from a nickel oxide ore, the sulfuric acid aqueous solution is a mother liquid composed of the sulfuric acid aqueous solution containing the nickel and the cobalt to be recovered through a leaching step, a solid-liquid separation step, and a neutralization step, and the impurity metals containing any of iron, magnesium, and manganese at least one or more.

### Effects of the Invention

According to the present invention, the invention enables the reduction of the usage amount of expensive high alkaline neutralizer, and application of a neutralization treatment for efficiently neutralizing and removing impurity metal elements in the barren solution.

### BRIEF DESCRIPTION OF THE DRAWINGS

FIG. 1 is a flow chart of a hydrometallurgical process using the high pressure acid leach for nickel oxide ore.

FIG. 2 is a flow chart of a neutralization method according to the present invention.

FIG. 3 is a view showing the results of the additive amount of neutralizer used in Example 1 and Comparative Examples 1 and 2.

### DETAILED DESCRIPTION OF THE INVENTION

Hereinafter, a detailed description will be made to a neutralization method according to the present invention in the following order with reference to the accompanying drawings. It is to be noted that the present invention is not necessarily limited to the embodiments to be mentioned later, or rather may be properly modified without departing from the gist of the present invention.

1. Summary of invention

2. Hydrometallurgical process for nickel oxide ore

3. Neutralization method
3-1. First neutralization treatment step
3-2. Second neutralization treatment step

4. Examples

### 1. SUMMARY OF INVENTION

A neutralization method according to the present invention is for neutralizing and removing a residual impurity metal ion in a barren solution to be produced through a sulfurization treatment for producing a sulfide containing nickel and cobalt by blowing a hydrogen sulfide gas into a sulfuric acid aqueous solution containing the nickel and the cobalt, as well as impurity metals containing any of iron, magnesium, and manganese at least one or more.

Specifically, the neutralization method includes a first neutralization treatment step of applying a neutralization treatment to the above-mentioned barren solution, with a range of pH 5.0 to 6.0 as the end point, using calcium carbonate slurry as a first neutralizer, and a second neutralization treatment step of applying a neutralization treatment to a solution produced in the first neutralization treatment step using a second neutralizer, to produce a sediment containing metals remained in the barren solution and a post-neutralization solution from which a metal ion is removed.

Thus, in the neutralization method according to the present invention, it is important to gradually apply a neutralization treatment with a predetermined pH range as the end point, using two types of neutralizers. One type of neutralizer is calcium carbonate slurry and that is an inexpensive neutralizer. A neutralization treatment at a first stage is applied by using the calcium carbonate slurry.

According to such a neutralization method, since the neutralization treatment is first applied with a predetermined pH range at the end point using the inexpensive calcium carbonate slurry as a first neutralization treatment step, it allows the effective reduction of the usage amount of high alkaline neutralizer, such as conventionally used slaked lime slurry. Thus it allows efficient neutralization and removal of an impurity metal ion. This prevents an excess increase in a treatment cost, thereby enabling an efficient treatment, even when the amount of barren solution to be treated is increased.

### 2. HYDROMETALLURGICAL PROCESS FOR NICKEL OXIDE ORE

No special limitation is imposed on the above-mentioned sulfuric acid aqueous solution containing the nickel, the cobalt, and impurity metal elements, but a wide variety of solutions may be used. For example, in the hydrometallurgical process based on the high pressure acid leach, in which nickel is recovered from nickel oxide ore. a mother liquid may be used, which is composed of a sulfuric acid aqueous solution containing the nickel and the cobalt to be recovered through a leaching step, a solid-liquid separation step, and a neutralization step, and impurity metals containing any of iron, magnesium, and manganese at least one or more.

The neutralization method of the present embodiment may take, for example, a barren solution, as a treatment object, discharged from the sulfurization step, in which a sulfide containing the nickel and the cobalt is produced by blowing a hydrogen sulfide gas into a mother liquid composed of a sulfuric acid aqueous solution containing the nickel and the cobalt produced by the hydrometallurgical process for nickel oxide ore, and impurity metals.

Herein, a description will be made to the outline of the hydrometallurgical process for nickel oxide ore. Hereupon, a description will proceed by taking the hydrometallurgical process using the high pressure acid leach as a specific example.

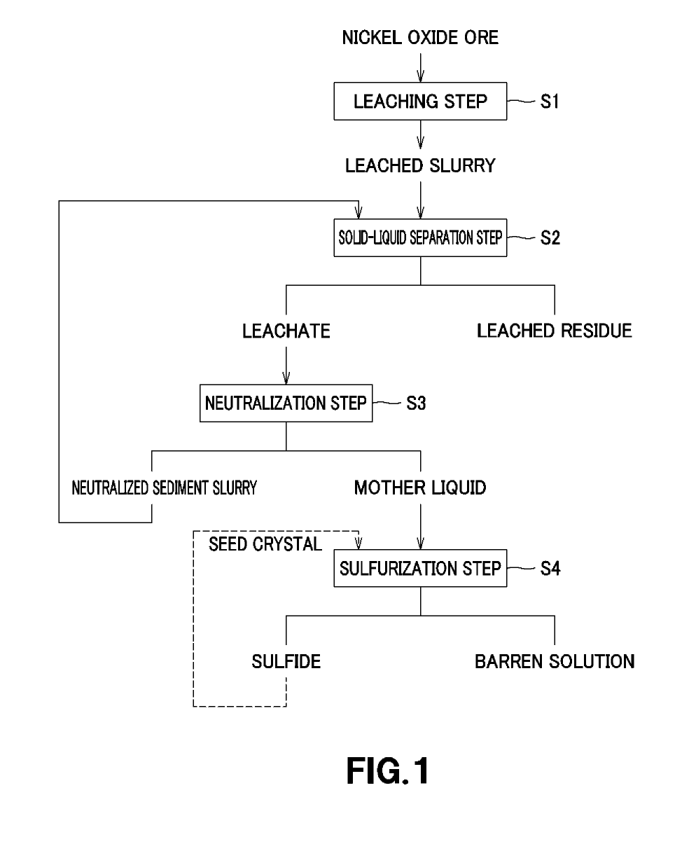

FIG. 1 shows an example of a flow chart of the hydrometallurgical process by the high pressure acid leach for nickel oxide ore. As shown in FIG. 1, the hydrometallurgical process for nickel oxide ore includes a leaching step S1 of leaching nickel or the like from the nickel oxide ore; a solid-liquid separation step S2 of separating the produced leached slurry into leachate and a leached residue; a neutralization step S3 of neutralizing the leachate to separate the neutralized leachate into a mother liquid for nickel recovery and neutralized sediment slurry; and a sulfurization step S4 of sulfurizing a sulfuric acid aqueous solution that is a mother liquid by blowing a hydrogen sulfide gas thereinto to produce a sulfide containing nickel and cobalt and a barren solution.

### (1) Leaching Step

In the leaching step S1, slurry of the nickel oxide ore is stirred, under temperature of 220 to 280 degrees C, by adding a sulfuric acid thereto, to produce leached slurry composed of leachate and a leached residue. In the leaching step S1, a high temperature pressurized vessel (autoclave) is used, for example.

As an example of the nickel oxide ore used in the leaching step S1 includes chiefly so-called laterite ore, such as limonite ore and saprolite ore. The nickel content of the laterite ore is typically 0.8 to 2.5 wt % and is contained as hydroxide or silicic magnesia ore (magnesium silicate). The iron content is 10 to 50 wt % and is contained chiefly in the form of trivalent hydroxide (goethite) where a portion of bivalent iron is contained in the silicic magnesia ore.

Specifically, in the leaching step S1, a leaching reaction and a high temperature thermal hydrolysis reaction represented by the following formulae (1) to (5) occur, where leaching of nickel and cobalt or the like as sulfate and immobilization of leached iron sulfate as hematite are taken place. However, as immobilization of a ferrous ion progresses incompletely, a liquid portion of the produced leached slurry generally contains a bivalent and a trivalent ferrous ion, in addition to nickel and cobalt or the like.

Leaching reaction

MO+H₂SO₄ [symbol] MSO₄+H₂O formula (1)

(where M denotes Ni, Co, Fe, Zn, Cu, Mg, Cr, Mn or the like),

2Fe(OH)₃+3H₂SO₄ [symbol] Fe₂(SO₄)₃+6H₂O formula (2)

FeO+H₂SO₄ [symbol] FeSO₄+H₂O formula (3)

High temperature thermal hydrolysis reaction

2FeSO₄+H₂SO₄+½O₂ [symbol] Fe₂(SO₄)₃+H₂O formula (4)

Fe₂(SO₄)₃+3H₂O [symbol] Fe₂O₃+3H₂SO₄ formula (5)

No special limitation is imposed on the slurry concentration in the leaching step S1, but it is preferable to adjust for the slurry concentration of leached slurry to be 15 to 45 wt %. Further, no special limitation is imposed on the additive amount of sulfuric acid used in the leaching step S1, but the excessive amount is used to the degree that iron contained in the ore is leached. For example, the excessive amount shall here be 300 to 400 kg per ore of 1 ton. When the additive amount of sulfuric acid per ore of 1 ton is to exceed 400 kg, it is unpreferable because a sulfuric acid cost increases.

### (2) Solid-Liquid Separation Step

In the solid-liquid separation step S2, leached slurry produced in the leaching step S is multistage cleaned to produce leachate containing nickel and cobalt, and a leached residue.

No special limitation is imposed on the multistage cleaning method in the solid-liquid separation step S2, but it is preferable to use the Counter Current Decantation (CCD) in which a cleaning solution not containing nickel is brought into contact with a countercurrent. This enables the reduction of cleaning solution to be newly introduced into the system, thereby attaining a recovery rate of 95% or more for nickel and cobalt.

### (3) Neutralization Step

In the neutralization step S3, a mother liquid for nickel recovery and neutralized sediment slurry containing trivalent ferrous ion are produced by adding calcium carbonate so that pH of the leachate is 4.0 or less, preferably is 3.2 to 3.8, while suppressing oxidation of the leachate separated in the solid-liquid separation step S2. In the neutralization step S3, applying a neutralization treatment to the leachate in this way neutralizes an excess acid used in the leaching step S1 by the high temperature acid leach, and removes a trivalent ferrous ion and an aluminium ion or the like remained in the solution. Note that when pH of the leachate exceeds 4.0, more hydroxide of nickel is generated.

The neutralized sediment slurry produced in the neutralization step S3 can be transferred to the solid-liquid separation step S2, as needed. Thereby, it becomes possible to effectively recover nickel contained in the neutralized sediment slurry. Specifically, iteratively transferring the neutralized sediment slurry to the solid-liquid separation step S2, operated under a low pH condition, enables acceleration of dissolution of nickel hydroxide, produced by a local reaction with moisture adhered on the neutralized sediment and a surface of the neutralized sediment, concurrently with cleaning of the leached residue, which reduces nickel that is a recovery loss.

### (4) Sulfurization Step

In the sulfurization step S4, a sulfurization reaction is generated by blowing a hydrogen sulfide gas into a sulfuric acid aqueous solution that is a mother liquid for nickel recovery produced in the neutralization step S3 to thereby produce a sulfide containing nickel and cobalt and a barren solution.

Where zinc is contained in the mother liquid, it may be allowed to perform a process, in which zinc is selectively separated as a sulfide, prior to producing a sulfide composed of nickel and cobalt by a sulfurization reaction. As a process for selectively separating the zinc, a weak condition is created at the time of a sulfurization reaction to suppress a rate of the sulfurization reaction, which inhibits coprecipitation of nickel whose concentration is high as compared with that of zinc, for selectively removing the zinc.

As described above, the mother liquid is a sulfuric acid aqueous solution containing nickel and cobalt produced through the neutralization step S3 after leaching the nickel oxide ore. Specifically, for example, a sulfuric acid aqueous solution may be used, which has pH of 3.2 to 4.0, nickel concentration of 2 to 5 g/L, and cobalt concentration of 0.1 to 1.0 g/L. and in addition contains impurity metal elements containing, for example, any of iron, magnesium, and manganese at least one or more as impurity compositions. The impurity metal compositions greatly vary depending on oxidation-reduction potential, operating condition of autoclave, and grade of ore, but impurity metal elements such as iron, magnesium, and manganese are generally contained therein about several g/L or so.

Herein, although alkaline earth metals such as iron, manganese, alkali metal, and magnesium that are impurity metal compositions contained in the sulfuric acid aqueous solution are existing relatively in large quantities with respect to nickel and cobalt to be recovered, stability thereof, as a sulfide, to be produced in the sulfurization step S4 is low. For this reason, these impurity metal compositions are not contained in a sulfide to be produced but they are contained in a barren solution (post-sulfurized treatment solution) produced by removing a produced sulfide. Incidentally, the barren solution has pH of 1.0 to 3.0 or so.

Thus, in the sulfurization step S4, a sulfide which contains nickel and cobalt containing less impurities and a barren solution whose nickel concentration is stabilized at a low level are produced and recovered. As a recovery method, slurry of the sulfide produced by a sulfurization reaction is subject to sedimentation separation treatment by utilizing a precipitator such as a thickener. The sulfide that is a sediment is separated and recovered from the bottom of the thickener, and constituents in an aqueous solution are overflowed therefrom and recovered as a barren solution.

### 3. NEUTRALIZATION METHOD

As mentioned above, the barren solution produced through the sulfurization step S4 of the hydrometallurgical process for nickel oxide ore contains an impurity metal ion containing any of iron, magnesium, and manganese at least one or more. Accordingly, when discharging the barren solution outside of the system, application of a neutralization treatment to remove a residual metal ion in the barren solution is required.

Moreover, even when the barren solution is iteratively used in the above-mentioned hydrometallurgy, it is preferable to apply a neutralization treatment to bring impurity compositions into a state where the compositions are reduced to the utmost.

Conventionally, in the neutralization treatment to a barren solution, a high alkaline neutralizer, such as, for example, slaked lime slurry has been used in order to achieve pH concentration necessary for neutralization. However, the high alkaline neutralizer of this kind requires a cumbersome pretreatment and a pretreatment facility therefor, when the mount of usage increases, due to the increased amount of generation of a barren solution from the sulfurization step. Accordingly, although neutralizer such as slaked lime slurry is relatively advantageous in terms of cost as compared with another neutralizer, there still remains a problem unsolved that it has a great impact on a finish cost when the amount of usage swells out stupendously with an increase in the amount of barren solution to be treated.

Then, in the neutralization method according to the present invention, it takes a measure of replacing a portion of the neutralizer to be used, such as, for example, slaked lime slurry with inexpensive calcium carbonate slurry, and a gradual neutralization treatment is applied by using the two types of neutralizers.

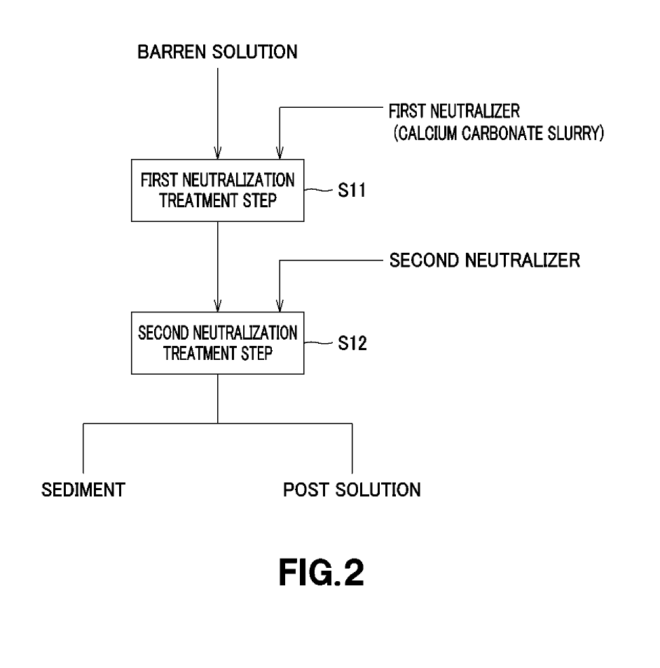

Specifically, as shown in a flow chart of FIG. 2, the neutralization method includes a first neutralization treatment step S11 of applying a neutralization treatment to a barren solution, with a predetermined pH range as the end point by using calcium carbonate slurry, as a first neutralizer; and a second neutralization treatment step S12 of applying a neutralization treatment to a solution produced in the first neutralization treatment step S11 by using a second neutralizer, to produce a sediment containing impurity metals and a post-neutralized solution.

### <3-1. First Neutralization Treatment Step>

In the first neutralization treatment step S1, calcium carbonate slurry is used as a neutralizer and a neutralization treatment is applied to a barren solution produced through the above-mentioned sulfurization step S4.

The calcium carbonate slurry used in the first neutralization treatment step S11 is an inexpensive neutralizer. Therefore, applying the first the neutralization treatment at a first stage by using the inexpensive calcium carbonate slurry, as a first neutralizer, allows the reduction of the usage amount of high alkaline neutralizer to be used in a neutralization treatment at a second stage to be mentioned later.

In the first neutralization treatment step in which a gradual neutralization is applied, it is important to adjust pH for applying a neutralization treatment, to a predetermined pH range as the end point of neutralization treatment. Specifically, in the first neutralization treatment step S11, a neutralization treatment is applied, with pH at the end point as a range of 5.0 to 6.0, preferably as a range of 5.4 to 5.8.

Thus, in the first neutralization treatment step S11, calcium carbonate slurry is used as a neutralizer, and the neutralization treatment at a first stage is applied whose pH at the end point is adjusted and set to 5.0 to 6.0. This reduces the usage amount of high alkaline neutralizer as described above, and in addition, the total usage amount of neutralizer through the neutralization treatment is reduced. As a result, it realizes efficient neutralization treatment with a reduced treatment cost, thereby preventing an excessive increase in a treatment cost, even when the amount of barren solution to be treated is increased.

Herein, in case pH at the end point in the first neutralization treatment is less than 5.0, the first neutralization treatment becomes insufficient, leading to an increased load of the neutralization treatment in the second neutralization treatment S12 to be mentioned later, so that the usage amount of the second neutralizer increases. Meanwhile, in case pH at the end point exceeds 6.0, a load of the first neutralization treatment increases, resulting in an increase in the usage amount of the calcium carbonate slurry. Furthermore, even when the load of the first neutralization treatment is increased by adjusting pH at the end point so as to exceed 6.0, the usage amount of the neutralizer in the second neutralization treatment step S12 scarcely changes. Thus, the usage amount of the neutralizer in the entire neutralization treatment increases, ending in economically inefficient.

Moreover, applying the neutralization treatment at a first stage, preferably with a range of pH 5.4 to 5.8 as the end point, enables the more effective reduction of the usage of neutralizer in the first and the second neutralization treatments, thereby allowing an efficient treatment, without excessively increasing a treatment cost, even in the case of the increased amount of barren solution to be treated.

As no special limitation is imposed on measurement of pH and measurement can be made with a well-known technique, it is able to determine where the end point is based on the measured pH. For example, a pH meter is provided within a neutralization reaction tank to enable pH of solution within the neutralization reaction tank to be measured at all times, for observing pH that changes with the progress of a neutralization reaction incident to the addition of neutralizer, and for determining where the end point of neutralization treatment is.

### <3-2. Second Neutralization Treatment Step>

In the second neutralization treatment step S12, a neutralization treatment is applied to a solution produced through the first neutralization treatment step S11 by using a second neutralizer. With the second neutralization treatment, a sediment containing impurity metals and a post-neutralization solution from which the impurity metals are removed are produced.

No special limitation is imposed on the second neutralizer as far as it is a high alkaline neutralizer, but slaked lime slurry, sodium hydrate, and sodium carbonate or the like may be used, for example. Among other things, it is particularly preferable to use the relatively inexpensive slaked lime slurry from the perspective of economic efficiency.

As mentioned above, a neutralization treatment has been conventionally applied only by using the high alkaline neutralizer, such as slaked lime slurry. However, an increased barren solution to be treated causes an increase in the amount of necessary neutralizer. The increased amount of neutralizer induces an excessively elevated treatment cost, even when relatively inexpensive slaked lime slurry is used, precluding the conventional technique from applying a treatment with high economic effectivity. Contrarily, since in the neutralization method according to the present invention, a neutralization treatment is first applied, as mentioned above, with a predetermined pH range as the end point, by using calcium carbonate slurry, in the first neutralization treatment step S11, the invention enables the effective reduction of the amount of high alkaline neutralizer, such as slaked lime slurry, used in the second neutralization treatment. This prevents an excessive increase in a treatment cost, even when the amount of barren solution to be treated increases, which allows an efficient treatment.

In the neutralization treatment of the second neutralization step S12, it is preferable to apply a treatment by adjusting pH to a range of pH 8.5 to 9.5 as a pH range at the end point.

In case pH at the end point in the second neutralization treatment is less than 8.5, a sediment of impurity metal elements, such as iron, magnesium, and manganese contained in a barren solution are deficiently produced; therefore it is likely that an impurity metal ion is remained in a post-neutralization solution. Meanwhile, in case pH at the end point exceeds 9.5, precipitate formation of the impurity metals no longer progresses any further to cause an increased load of the neutralization treatment. The usage amount of the second neutralizer, such as slaked lime slurry, increases, resulting in deteriorated economic efficiency.

Preferably, the neutralization treatment at a second stage is applied, with a range of pH 8.9 to 9.1 as the end point. This allows the effective production of the sediment of the impurity metal elements in the barren solution, while suppressing the usage amount of the second neutralizer to the minimum, thereby applying more efficient neutralization and removal treatments.

Even for pH control in the second neutralization treatment step S12, it can determine where the end point of the neutralization treatment is by using a well-known technique, as with pH measurement in the first neutralization treatment step S11 and pH control based thereon.

The sediment containing the impurity metal elements produced through the second neutralization treatment step S12, and a post-neutralized solution from which the impurity metals are removed can be separated and recovered by applying a well-known solid-liquid separation treatment.

### 4. EXAMPLES

Hereinafter, while a description will be made to Examples according to the present invention, the invention is not necessarily limited to the following Examples.

### Example 1

In the hydrometallurgical process for nickel oxide ore, a sulfurization step was applied, in which a sulfide containing nickel and cobalt was produced by blowing a hydrogen sulfide gas into a mother liquid composed of a sulfuric acid aqueous solution containing the nickel and the cobalt and impurity metals containing iron, magnesium, and manganese or the like recovered through the leaching step, the solid-liquid separation step, and the neutralization step. Subsequently, a neutralization treatment for neutralizing and removing an impurity metal ion contained in a barren solution was applied to the barren solution discharged from the sulfurization step.

Specifically, in the neutralization treatment of Example 1, a first neutralization treatment was applied, in which calcium carbonate slurry having density of 1.3 g/cm³ was first added to a barren solution of 1 m³ (pH 1.7), as a first neutralizer, and then the barren solution was neutralized until pH at the end point reaches 5.5 (pH (1) at the end point).

Subsequently, a second neutralization treatment was applied to a solution after being subjected to the first neutralization treatment, in which slaked lime slurry having density of 1.2 g/cm³ was added as a second neutralizer and then the solution was neutralized, until pH at the end point reached 9.0 (pH (2) at the end point). At this moment, the additive amount of respective neutralizers used in the first and second neutralization treatments was found.

### Comparative Example 1

In Comparative Example 1, a neutralization treatment was applied as with Example 1 to find the additive amount of the respective neutralizers, except that pH at the end point in the first neutralization treatment was set to 6.5 (pH (1) at the end point).

### Comparative Example 2

In Comparative Example 2, a neutralization treatment was applied to a barren solution of 1 m³, by using only slaked lime slurry as a neutralizer until pH at the end point reaches pH 9.0 at the end point (despite only 1 stage, conveniently it shall be “pH (2) at the end point”). Then, the additive amount of the neutralizer became necessary on this occasion was found.

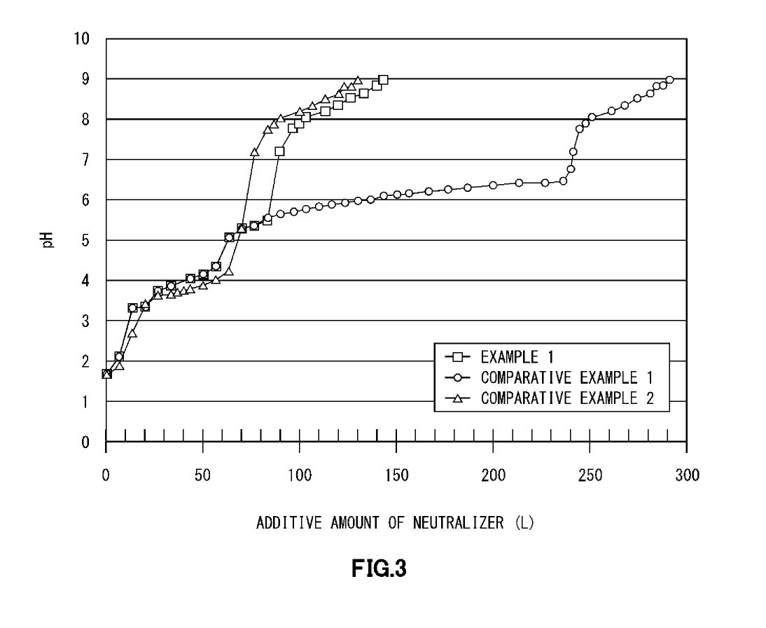

FIG. 3 and Table 1 show the results of the additive amount of the neutralizer obtained in Example 1, and Comparative Examples 1 and 2.

TABLE 1

| | | Comparative | Comparative |
|---|---|---|---|
| | Example 1 | Example 1 | Example 2 |
| Initial pH | 1.7 | 1.7 | 1.7 |
| pH (1) at the end | 5.5 | 6.5 | — |
| point | | | |
| Additive amount | 83 | 235 | — |
| of calcium | | | |
| carbonate slurry | | | |
| (L) | | | |
| pH (2) at the end | 9.0 | 9.0 | 9.0 |
| point | | | |
| Additive amount | 60 | 55 | 130 |
| of slaked lime | | | |
| slurry (L) | | | |

As can be seen from the results shown in FIG. 3 and Table 1, in Example 1 in which the neutralization treatment at a first stage was applied, with pH at the end point ranging from 5.0 to 6.0 as pH 5.5, by using calcium carbonate slurry as a first neutralizer and then the neutralization treatment at a second stage was applied by using high alkaline slaked lime slurry as a second neutralizer, the additive amount of the slaked lime slurry is 60 L. Thus, an efficient treatment was performed. The total usage amount of the neutralizer of the entire neutralization treatment was 143 L. Out of the total usage amount, 80 L accounted for inexpensive calcium carbonate slurry used in the neutralization treatment at a first stage. As mentioned above, reducing the usage amount of the slaked lime slurry was realized, and also substantially reducing a treatment cost in the entire neutralization treatment.

Meanwhile, while the neutralization treatment at two stages was applied by using two types of neutralizers, as with Example 1, in Comparative Example 1 in which pH at the end point of the first neutralization treatment was set to 6.5, a load of the neutralization treatment at a first stage increased and the additive amount of the calcium carbonate slurry surged up to 235 L. It followed that the additive amount ran up to the amount of 2.5 times or more as compared with that of Example 1. Additionally, although in Comparative Example 1, a load of the neutralization treatment at a first stage was made larger, the additive amount of the slaked lime slurry used in the neutralization treatment at a second stage ran into 55 L, in which case the additive amount was almost unchanged as compared with that of Example 1. Consequently, the total usage amount of the neutralizer in the entire neutralization treatment was remarkably increased, and therefore it failed to apply an efficient neutralization treatment accordingly.

In Comparative Example 2 in which the neutralization treatment was applied, as in the conventional way, by using only the slaked lime slurry, the additive amount of the slaked lime slurry surged up to 130 L. The usage amount of the slaked lime slurry was equivalent to the amount twice or more as compared with that of the slaked lime slurry in Example 1. The usage amount of the neutralizer in Comparative Example 2 was almost the same as the total usage amount of the neutralizer in Example 1, but a treatment cost was by far increased in Comparative Example 2, as compared with Example 1, in which the gradual neutralization treatment was applied by using inexpensive calcium carbonate slurry, as a first neutralizer. From this, it was presumed that in such a treatment, a treatment cost is noticeably increased, with an increase in the amount of barren solution to be treated.

1. A neutralization method for neutralizing and removing a metal ion remained in a barren solution produced through a sulfurization treatment for producing a sulfide containing nickel and cobalt by blowing a hydrogen sulfide gas into a sulfuric acid aqueous solution containing the nickel and the cobalt, and impurity metals containing at least more than one of iron, magnesium, and manganese, the method comprises:
a first neutralization treatment step of applying a neutralization treatment to the barren solution, with a range of pH 5.0 to 6.0 as an end point, by using calcium carbonate slurry as a first neutralizer; and
a second neutralization treatment step of applying a neutralization treatment to a solution produced in the first neutralization treatment step by using slaked lime slurry as a second neutralizer to produce a sediment containing a metal remained in the barren solution and a post-neutralized solution from which the metal ion is removed.

2. (canceled)

3. The neutralization method according to claim 1, wherein pH at the end point in the first neutralization treatment step is within a range of 5.4 to 5.8.

4. The neutralization method according to claim 1, wherein in the second neutralization treatment step, a neutralization treatment is applied, with a range of pH 8.5 to 9.5 as the end point.

5. The neutralization method according to claim 1, wherein in a hydrometallurgical process based on high pressure acid leach for recovering the nickel from a nickel oxide ore, the sulfuric acid aqueous solution is a mother liquid composed of the sulfuric acid aqueous solution containing the nickel and the cobalt to be recovered through a leaching step, a solid-liquid separation step, and a neutralization step, and the impurity metals containing at least more than one of iron, magnesium, and manganese.
